(19) United States
(12) Patent Application Publication
(10) Pub. No.: US 2005/0250484 A1
(43) Pub. Date: Nov. 10, 2005

(54) Device for automatic data retransmission

(75) Inventors: Stephane Rouchy, Saint-Armel (FR); Serge Le Potier, Rennes (FR); Luc Vacquie, St Jean L'Herm (FR)

Correspondence Address: YOUNG & THOMPSON, 745 SOUTH 23RD STREET, 2ND FLOOR, ARLINGTON, VA, 22202, US

(73) Assignee: FRANCE TELECOM, PARIS (FR)

(21) Appl. No.: 10/521,788

(22) PCT Filed: Jul. 18, 2003
(86) PCT No.: PCT/FR03/02290

§ 371 Date: Jan. 21, 2005

(30) Foreign Application Priority Data
Jul. 22, 2002 (FR) 02/09289

(51) Int. Cl. H04M 3/00

(52) U.S. Cl. 455/419; 455/418

(57) ABSTRACT

This information retransmission device (2) includes elements (21) for exchanging information with a remote server (4) via a telecommunications network (6). It is characterized in that it further includes automatic elements (23) for detecting the presence of a nearby output device (8) and for retransmitting information received from the remote server (4) from the device (2) to the output device (8) that has been detected nearby.

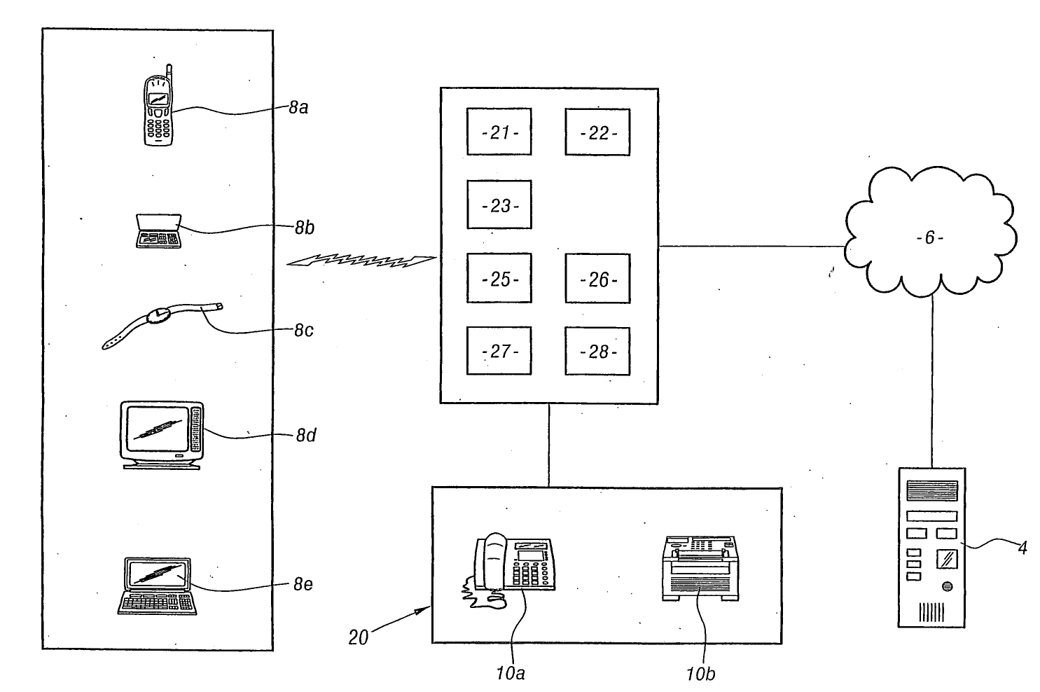

The present invention relates to an information retransmission device comprising means for exchanging information with a remote server over a tele-communications network, and to a system comprising an information retransmission device of the above kind and a corresponding output device.

There exist at present devices of the above kind in the form of modems having their own power supply and connected to the public switched telecommunications network (PSTN), for example.

Modems of the above kind are adapted to receive and store information sent by a remote server for transmitting information, such as an Internet server or a facsimile machine.

A user may subsequently recover the information by interrogating the modem using an appropriate output device connected to it, such as a computer.

Devices of the above kind and systems using them are complex, costly, and not very user friendly.

That kind of device has a plurality of functions and requires its own power supply and a man/machine interface, thereby increasing its size and its cost.

Moreover, the corresponding output devices take the form of complex and costly data processing devices, for example.

Finally, in systems of the above kind, information is retransmitted to a user only at the request of the user, thus making the system not very user friendly.

The object of the invention is therefore to propose a device and a system for retransmission of information that are user friendly and inexpensive.

To this end, the invention consists in an information retransmission device comprising means for exchanging information with a remote server via a tele-communications network and characterized in that it further comprises automatic means for detecting the presence of a nearby output device and automatic means for retransmitting information received from said remote server from said device to an output device that has been detected nearby.

According to other features of the device of the invention:

said information exchange means are adapted to interrogate said remote server via said tele-communications network on detection of a nearby output device in order to receive information from said server and retransmit it directly to said detected output device;

the device comprises means for storing information in order to store information received from said remote server and to retransmit it subsequently to an output device detected nearby;

the device comprises means for setting its operating parameters enabling a user and/or the remote server to set parameters for retransmission of received information as a function of the identity of the detected output device;

the device further comprises means for selecting and/or converting received information in order to enable the retransmission of some or all of said information in a format suited to output on the detected output device;

the device is also connected to at least one standard telephone device and comprises means for identifying the addressee of an incoming call and means for switching calls in order to enable the switching of incoming calls between said at least one standard telephone device and said information exchange means;

the device is supplied with power by virtue of its connection to the telecommunications network;

the device is adapted to exchange information with said output device by means of a wireless radio connection;

the device exchanges information with said output device in accordance with the “BLUETOOTH” protocol and said automatic means for detecting the presence of a nearby output device and said automatic information retransmission means take the form of a BLUETOOTH communications module;

the device is integrated into an adapter.

The invention also provides an information retransmission system comprising a device for retransmitting information received from a remote server over a telecommunications network in order to retransmit it to a output device comprising means for receiving information coming from said information retransmission device and means for output of that information, which system is characterized in that said information retransmission device is a device as defined hereinabove.

According to other features of this system, said output device is an output device selected from the group comprising the following devices:

a mobile telephone;

a personal digital assistant;

a watch;

a television; and

a portable computer.

The invention will be better understood after reading the following description, which is given by way of example only and with reference to the drawing, which represents diagrammatically a system for retransmitting information using a device of the invention.

The system represented comprises an information retransmission device 2 of the invention connected to a remote server 4 via a telecommunications network 6.

For example, the remote server 4 is a Minitel server or a Télétel server and the communications network 6 is the public switched telecommunications network (PSTN).

The device 2 is also connected to a nearby output device 8 by means of a wireless radio connection.

For example, the output device 8 is a mobile telephone 8a, a personal digital assistant (PDA) 8b, a watch 8c, a television 8d, a portable computer 8e, or any other suitable device.

Regardless of its nature, the output device 8 comprises means for receiving information via a wireless radio connection and output means for output of information received, such as a display screen or a loudspeaker, for example.

In the example described, the information retransmission device 2 and the output device 8 communicate using the “BLUETOOTH” radio information transmission protocol.

The device 2 is advantageously also connected to standard telephone devices 10 such as a telephone 10a and a facsimile machine 10b.

The device 2 of the invention comprises means 21 for exchanging information over the telecommunications network 6, for example a conventional modem adapted to exchange data in accordance with the V.23 and V.34 or V.90 protocols. The device 2 also comprises information storage means 22.

In the example described, the information retransmission device 2 further comprises a BLUETOOTH communications module 23 comprising a BLUETOOTH transceiver, a microcontroller and a flash memory, for example. The module 23 automatically detects an output device that is nearby, i.e. at a distance of the order of a few meters, and exchanges information with the output device.

The information retransmission device 2 advantageously further comprises means 25 for setting its operating parameters and means 26 for selecting information and/or converting information between a plurality of formats. Thus a user and/or the remote server 4 may set the operating parameters of the information retransmission device 2 and in particular specify a list of output devices 8 authorized to receive information and the format in which information must be retransmitted as a function of the identity of each output device and any other information relating to the operation of the device.

For example, the parameters are set by the portable computer 8a by way of an exchange of information with the information retransmission device 2 in accordance with the BLUETOOTH protocol.

Finally, the information retransmission device 2 being connected to the standard telephone devices 10, it comprises means 27 for identifying the called equipment and means 28 for switching calls in order to be able to identify the addressee of an incoming call and switch incoming calls between the standard telephone devices 10a and 10b and the information exchange means 21.

In the embodiment described, the power supply necessary for the operation of the information retransmission device 2 is provided exclusively by the 48 V potential difference between the wires forming the twisted pairs of the PSTN 6.

Thus the absence of any power supply means specific to the information retransmission device 2 and appropriate miniaturization of its components yield a device 2 of low cost and small size.

For example, the information retransmission device 2 is integrated into a telephone jack connected directly to the PSTN 6.

This telephone jack is advantageously an adapter comprising a male connector and a female connector so that it may be connected to the PSTN 6 and also to the standard telephone devices 10a and 10b.

Of course, the device 2 may take other forms and have its own power supply.

Moreover, the device 2 may comprise a rechargeable battery supplying additional power and recharged by the PSTN 6.

In operation, the device 2 receives calls coming from the PSTN 6.

These incoming calls are received by the identification means 27 and switched by the switching means 28.

For example, if the calling number is a telephone number, the incoming call corresponds to a telephone call or a facsimile call and is switched to the standard telephone devices 10a and 10b.

If the call received is identified as an information transmission call, for example by recognizing the calling number or a suffix in the calling number, the switching means 28 switch the call to the information exchange means 21.

The identification means 27 are advantageously adapted to manage a “call waiting” type service and to interrupt transmission of information on reception of an incoming call addressed to the standard facsimile devices 10a or 10b.

Following exchanges of protocol data, the means 21 receive from the remote server 4 information which is then stored in the storage means 22.

Once the information has been stored, the BLUETOOTH communications module 23 scans continuously for the presence of a nearby output device 8, for example by periodically sending out interrogation radio messages with a range of a few meters.

If an output device 8 subsequently passes near the information retransmission device 2, it responds to the interrogation messages, with the result that its presence is automatically detected by the BLUETOOTH communications module 23 and it is identified.

The selection and/or conversion means 26 select some or all of the information stored in the storage means 22 and convert it into a format suited to output by the output device that has been detected, as a function of parameter information stored with the aid of the means 25 for setting the operating parameters of the device 2.

The information selected and converted in this way is retransmitted automatically by the device 2 to the output device 8 in a suitable format for its subsequent output.

Of course, if an output device 8 has already been detected near the device 2 when it receives information, the information is retransmitted directly.

In one embodiment of the invention, a user takes out a subscription to the server 4 in order to receive weather forecasts, and the server 4 transmits to the information retransmission device 2 daily weather forecast information that is stored in the storage means 22.

For example, this information contains a series of items of information each in a format specific to a given output device.

A user subsequently passes near the retransmission device 2 wearing a watch 8c adapted to receive BLUETOOTH information and to display pictograms.

The watch 8c is detected automatically when it comes near the information retransmission device 2.

The selection and/or format conversion means 26 select, from the stored information, information that is appropriate to the watch 8c that has been detected near the retransmission device 2, and the module 23 automatically retransmits the weather forecast information in the form of pictogram display instructions in order to display on the screen of the watch 8c a pictogram representative of the weather forecast.

For example, the pictogram is an anthropomorphic pictogram with clothes and/or equipment indicating the nature of the weather forecast.

In another embodiment, a large quantity of information is transmitted by the server 4 to the device 2 in the form of information intended to be displayed on a television 8d.

To this end, the television is equipped with a BLUETOOTH receiver associated with a video signal generator which may be integrated into a SCART socket, for example.

The information is transmitted at night so as not to inconvenience the user by monopolizing the connection with the network 6.

All of the information is stored by the storage means 22, and when the television 8d is switched on it is detected automatically and the information is automatically retransmitted to it, in order to be available in response to a output command, through a video page or by embedding it in an existing image.

In a further embodiment, the device comprises no format conversion means and, at the time of exchanging information with the remote server, the device indicates the nature of the various available output devices and receives from the remote server information that has already been converted accordingly.

Furthermore, on detection of a nearby output device, the device may connect to the telecommunications network in order to interrogate the remote server and to receive in response information to be retransmitted directly.

Finally, the device described may be used with other information transfer networks, such as the Internet. In this case, the device may further have a wireless modem function.

Note that the information retransmission device is compact and inexpensive and automatically retransmits information immediately an output device is detected nearby.

1-10. (canceled)

11. An information retransmission device comprising means (21) for exchanging information with a remote server (4) via a switched telecommunications network (6) and further comprising automatic means (23) for detecting the presence of a nearby output device (8) and automatic means (23) for retransmitting information received from said remote server (4) from said device (2) to an output device (8) that has been detected nearby and that is supplied with power by virtue of its connection to the telecommunications network (6) and is integrated into an adapter.

12. A device according to claim 11, wherein said information exchange means (21) are adapted to interrogate said remote server (4) via said telecommunications network (6) on detection of a nearby output device (8) in order to receive information from said server (4) and retransmit it directly to said detected output device (8).

13. A device according to claim 11, comprising means (22) for storing information in order to store information received from said remote server (4) and to retransmit it subsequently to an output device (8) detected nearby.

14. A device according to claim 11, comprising means (25) for setting its operating parameters enabling a user and/or the remote server (4) to set parameters for retransmission of received information as a function of the identity of the detected output device (8).

15. A device according to claim 14, further comprising means (26) for selecting and/or converting received information in order to enable the retransmission of some or all of said information in a format suited to output on the detected output device (8).

16. A device according to claim 11, also being connected to at least one standard telephone device (10) and comprises means (27) for identifying the addressee of an incoming call and means (28) for switching calls in order to enable the switching of incoming calls between said at least one standard telephone device (10) and said information exchange means (21).

17. A device according to claim 11, being adapted to exchange information with said output device (8) by means of a wireless radio connection.

18. A device according to claim 17, exchanging information with said output device (8) in accordance with the “BLUETOOTH” protocol and said automatic means for detecting the presence of an output device (8) nearby and said automatic information retransmission means take the form of a BLUETOOTH communications module (23).

19. An information retransmission system comprising a device (2) for retransmitting information received from a remote server (4) over a telecommunications network (6) in order to retransmit it to a output device (8) comprising means for receiving information coming from said information retransmission device (2) and means for output of that information, wherein said information re-transmission device (2) is a device according to claim 11.

20. A system according to claim 9, wherein said output device (8) is an output device selected from the group comprising the following devices:
a mobile telephone (8a);
a personal digital assistant (8b);
a watch (8c);
a television (8d); and
a portable computer (8e).
